(19) United States
(12) Patent Application Publication
(10) Pub. No.: US 2023/0141577 A1
(43) Pub. Date: May 11, 2023

(54) METHOD AND APPARATUS FOR VIDEO ENCODING AND DECODING

(71) Applicant: InterDigital VC Holdings France, Cesson Sevigne (FR)

(72) Inventors: Karam Naser, Mouazé (FR); Fabrice Le Leannec, Betton (FR); Tangi Poirier, Thorigné-Fouillard (FR); Franck Galpin, Thorigne-Fouillard (FR)

(21) Appl. No.: 17/915,628

(22) PCT Filed: Mar. 24, 2021
(86) PCT No.: PCT/EP2021/057634

§ 371 Date: Sep. 29, 2022

(30) Foreign Application Priority Data
Mar. 31, 2020 (EP) 20315089.1

(51) Int. Cl. H04N 19/70; H04N 19/423

(52) U.S. Cl. CPC H04N 19/70; H04N 19/423

(57) ABSTRACT

Different implementations are described, particularly implementations for video encoding and decoding are presented. Accordingly, the encoding or decoding comprises obtaining parameters of a decoded picture buffer used in decoding an encoded picture. The signaling of parameters relative to the decoded picture buffer is controlled by a syntax data element sps_sublayer_dpb_params_flag related to the control of the presence of syntax elements in a decoded picture buffer parameters syntax structure in a SPS. According to a particular characteristic, the syntax data element sps_sublayer_dpb_params_flag is inferred to zero when the syntax data element sps_ptl_dpb_hrd_params_present_flag specifies that decoded picture buffer parameters syntax structure is not present in the SPS. According to another particular characteristic, the syntax data element sps_sublayer_dpb_params_flag is signaled in SPS when the syntax data element sps_ptl_dpb_hrd_params_present_flag specifies that decoded picture buffer parameters syntax structure is present in the SPS.

### TECHNICAL FIELD

At least one of the present embodiments generally relates to, e.g., a method or an apparatus for video encoding or decoding, and more particularly, to a method or an apparatus comprising obtaining parameters of a decoded picture buffer.

### BACKGROUND

The domain technical field of the one or more implementations is generally related to video compression. At least some embodiments relate to improving compression efficiency compared to existing video compression systems such as HEVC (HEVC refers to High Efficiency Video Coding, also known as H.265 and MPEG-H Part 2 described in “ITU-T H.265 Telecommunication standardization sector of ITU (10/2014), series H: audiovisual and multimedia systems, infrastructure of audiovisual services—coding of moving video, High efficiency video coding, Recommendation ITU-T H.265”), or compared to under development video compression systems such as VVC (Versatile Video Coding, a new standard being developed by JVET, the Joint Video Experts Team).

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction. A buffer, called decoded picture buffer or DPB, stores decoded pictures for reference, output reordering, or output delay specified for the hypothetical reference decoder (HRD) used in bitstream checking and decoder conformance. The decoded picture buffer is specified in related high level syntax elements. It is desirable to optimize the high-level syntax (HLS) of the decoded picture buffer.

### SUMMARY

The purpose of the invention is to overcome at least one of the disadvantages of the prior art. For this purpose, according to a general aspect of at least one embodiment, a method is presented. The method comprises decoding a syntax data element indicating whether a decoded picture buffer parameters syntax structure is present in a bitstream; and responsive to the decoded picture buffer parameters syntax structure being present, decoding at least a syntax data structure representative of parameters of a decoded picture buffer, wherein said parameters of a decoded picture buffer provide information on a buffer size, a maximum picture reorder number, and a maximum latency for one or more decoded picture.

According to another general aspect of at least one embodiment, a method is presented. The method comprises encoding a syntax data element indicating whether a decoded picture buffer parameters syntax structure is present in a bitstream; and responsive to the decoded picture buffer parameters syntax structure being present, encoding at least a syntax data structure representative of parameters of a decoded picture buffer, wherein said parameters of a decoded picture buffer provide information on a buffer size, a maximum picture reorder number, and a maximum latency for one or more decoded picture.

According to another general aspect of at least one embodiment, an apparatus is presented. The apparatus comprises one or more processors, wherein the one or more processors are configured to decode a syntax data element indicating whether a decoded picture buffer parameters syntax structure is present in a bitstream; responsive to the decoded picture buffer parameters syntax structure being present, decode at least a syntax data structure representative of parameters of a decoded picture buffer.

According to another general aspect of at least one embodiment, an apparatus is presented. The apparatus comprises one or more processors, wherein the one or more processors are configured to encode a syntax data element indicating whether a decoded picture buffer parameters syntax structure is present in a bitstream; responsive to the decoded picture buffer parameters syntax structure being present, encode at least a syntax data structure representative of parameters of a decoded picture buffer.

According to another general aspect of at least one embodiment, a method for encoding is presented. The encoding method comprises obtaining parameters of a decoded picture buffer used in decoding an encoded picture. The parameters of the decoded picture buffer provide information on a buffer size, a maximum picture reorder number, and a maximum latency for one or more decoded picture. The signaling of parameters relative to the decoded picture buffer is controlled by a syntax data element (sps_sublayer_dpb_params_flag) related to the control of the presence of syntax elements in a decoded picture buffer parameters syntax structure in a Sequence Parameter Set SPS. According to a particular characteristic, the syntax data element (sps_sublayer_dpb_params_flag) related to the control of the presence of syntax elements in a decoded picture buffer parameters syntax structure in SPS is inferred to zero when a syntax data element (sps_ptl_dpb_hrd_params_present_flag) related to at least a control of the presence of a decoded picture buffer parameters syntax structure in the SPS specifies that decoded picture buffer parameters syntax structure is not present in the SPS. According to another particular characteristic, the syntax data element (sps_sublayer_dpbparams_flag) related to the control of the presence of syntax elements in a decoded picture buffer parameters syntax structure in SPS is encoded or signaled in SPS when the syntax data element (sps_ptl_dpb_hrd_params_present_flag) related to at least a control of the presence of a decoded picture buffer parameters syntax structure in the SPS specifies that decoded picture buffer parameters syntax structure is present in the SPS. Advantageously, the signaling of the syntax data element (sps_sublayer_dpb_params_flag) related to the control of the presence of syntax elements in a decoded picture buffer parameters syntax structure in SPS is skipped when it is specified that decoded picture buffer parameters syntax structure is not present in the SPS.

According to another general aspect of at least one embodiment, a method for decoding is presented. The decoding method comprises obtaining parameters of a decoded picture buffer used in decoding a picture. The parameters of the decoded picture buffer provide information on a buffer size, a maximum picture reorder number, and a maximum latency for one or more decoded picture. As for the encoding, the signaling of parameters relative to the decoded picture buffer is controlled by at least one syntax data element (sps_sublayer_dpbparams_flag) related to the control of the presence of syntax elements in a decoded picture buffer parameters syntax structure in Sequence Parameter Set SPS. According to a particular characteristic, the syntax data element (sps_sublayer_dpbparams_flag) related to the control of the presence of syntax elements in a decoded picture buffer parameters syntax structure in Sequence Parameter Set SPS is inferred to zero when a syntax data element (sps_ptl_dpb_hrd_params_present_flag) related to at least a control of the presence of a decoded picture buffer parameters syntax structure in the SPS specifies that decoded picture buffer parameters syntax structure is not present in the SPS. According to another particular characteristic, the syntax data element (sps_sublayer_dpbparams_flag) related to a control of the presence of syntax elements in a decoded picture buffer parameters syntax structure in SPS is decoded from SPS when the syntax data element (sps_ptl_dpb_hrd_params_present_flag) related to at least a control of the presence of a decoded picture buffer parameters syntax structure in the SPS specifies that decoded picture buffer parameters syntax structure is present in the SPS. As for the encoding method, the syntax data element (sps_sublayer_dpb_params_flag) related to the control of the presence of syntax elements in a decoded picture buffer parameters syntax structure in Sequence Parameter Set SPS is implicitly decoded when it is specified that decoded picture buffer parameters syntax structure is not present in the SPS.

More generally, according to another general aspect of at least one embodiment, a method is presented. The method comprises obtaining a syntax data element (sps_sublayer_dpb_params_flag) related to a control of the presence of syntax elements in a decoded picture buffer parameters syntax structure in a Sequence Parameter Set SPS. According to a particular characteristic, the syntax data element (sps_sublayer_dpb_params_flag) related to a control of the presence of syntax elements in a decoded picture buffer parameters syntax structure in the SPS is inferred to zero if a syntax data element (sps_ptl_dpb_hrd_params_present_flag) related to at least a control of the presence of a decoded picture buffer parameters syntax structure in the SPS specifies that decoded picture buffer parameters syntax structure is not present in the SPS. According to another particular characteristic, the syntax data element (sps_sublayer_dpb_params_flag) related to a control of the presence of syntax elements in a decoded picture buffer parameters syntax structure in the SPS is signaled in SPS.

According to another general aspect of at least one embodiment, an apparatus for encoding is presented comprising means for implementing any one of the embodiments of the encoding method.

According to another general aspect of at least one embodiment, an apparatus for decoding is presented comprising means for implementing any one of the embodiments of the decoding method.

According to another general aspect of at least one embodiment, an apparatus for encoding is provided, comprising one or more processors, and at least one memory. The one or more processors is configured to implement any one of the embodiments of the encoding method.

According to another general aspect of at least one embodiment, an apparatus for decoding is provided, comprising one or more processors and at least one memory. The one or more processors is configured to implement any one of the embodiments of the decoding method.

According to another general aspect of at least one embodiment, a non-transitory computer readable medium is presented containing data content generated according to the method or the apparatus of any of the preceding descriptions.

According to another general aspect of at least one embodiment, a signal is provided comprising video data generated according to the method or the apparatus of any of the preceding descriptions.

One or more of the present embodiments also provide a computer readable storage medium having stored thereon instructions for encoding or decoding video data according to any of the methods described above. The present embodiments also provide a computer readable storage medium having stored thereon a bitstream generated according to the methods described above. The present embodiments also provide a method and apparatus for transmitting the bitstream generated according to the methods described above. The present embodiments also provide a computer program product including instructions for performing any of the methods described.

### BRIEF DESCRIPTION OF THE DRAWINGS

FIG. 1 illustrates an example of a decoding method according to a general aspect of at least one embodiment;

FIG. 2 illustrates an example of an encoding method according to a general aspect of at least one embodiment;

FIG. 3 illustrates an example of a method for obtaining a syntax data element related to a control of the presence of syntax elements in a decoded picture buffer parameters syntax structure in a Sequence Parameter Set according to a general aspect of at least one embodiment;

FIG. 4 illustrates a block diagram of an embodiment of video encoder in which various aspects of the embodiments may be implemented;

FIG. 5 illustrates a block diagram of an embodiment of video encoder in which various aspects of the embodiments may be implemented;

FIG. 6 illustrates a block diagram of an example apparatus in which various aspects of the embodiments may be implemented.

### DETAILED DESCRIPTION

It is to be understood that the figures and descriptions have been simplified to illustrate elements that are relevant for a clear understanding of the present principles, while eliminating, for purposes of clarity, many other elements found in typical encoding and/or decoding devices. It will be understood that, although the terms first and second may be used herein to describe various elements, these elements should not be limited by these terms. These terms are only used to distinguish one element from another.

The various embodiments are described with respect to the encoding/decoding of a picture.

They may be applied to encode/decode a part of picture, such as a slice or a tile, or a whole sequence of pictures. Besides, various embodiments are described with respect to the decoding of blocks (for example a coding unit CU)) and are easily derived to the coding of blocks.

Various methods are described above, and each of the methods comprises one or more steps or actions for achieving the described method. Unless a specific order of steps or actions is required for proper operation of the method, the order and/or use of specific steps and/or actions may be modified or combined.

First, several embodiments of a method for decoding a picture, a method for encoding a picture, a method for obtaining a DPB related syntax element according to the present principles are disclosed, then additional information and generic embodiments implementing the disclosed method are presented.

In a latest version of VVC, the decoded picture buffer parameters for sublayers are coded in Video Parameter Set VPS and Sequence Parameter Set SPS. The decoded picture buffer parameters are signaled using dpb_parameters( ) syntax structure which provides information of DPB size, maximum picture reorder number, and maximum latency for one or more output layers sets OLSs. When a dpb_parameters( ) syntax structure is included in a VPS, the OLSs to which the dpb_parameters( ) syntax structure applies are specified by the VPS. When a dpb_parameters( ) syntax structure is included in an SPS, it applies to the OLS that includes only the layer that is the lowest layer among the layers that refer to the SPS, and this lowest layer is an independent layer.

The syntax element vps_sublayer_dpb_params_present_flag is used to control the presence of max_dec_pic_buffering_minus1[ ], max_num_reorder_pics[ ], and max_latency_increase_plus1[ ] syntax elements in the dpb_parameters( ) syntax structures in the VPS. When not present, vps_sub_dpb_params_info_present_flag is inferred to be equal to 0. Specifically, in VPS, the following specifications are provided in VVC (as highlighted by underscore):

| | Descriptor |
|---|---|
| video_parameter_set_rbsp( ) { | |
| ... | |
| vps_max_sublayers_minus1 | u(3) |
| ... | |
| if( vps_max_layers_minus1 >0 ) | |
| vps_all_independent_layers_flag | u(1) |
| ... | |
| if( !vps_all_independent_layers_flag ) | |
| vps_num_dpb_params | ue(v) |
| ... | |
| if( vps_num_dpb_params >0 && | |
| vps_max_sublayers_minus1 >0 ) | |
| vps_sublayer_dpb_params_present_flag | u(1) |
| for( i = 0; i < vps_num_dpb_params; i++ ) { | |
| if( vps_max_sublayers_minus1 >0 && | |
| !vps_all_layers_same_num_sublayers_flag ) | |
| dpb_max_temporal_id[i ] | u(3) |
| dpb_parameters( dpb_max_temporal_id[i ], | |
| vps_sublayer_dpb_params_present_flag ) | |
| } | |
| ... | |

The skilled in the art will understand that, if number of decoder picture buffer parameters (vps_num_dpb_params) is greater than 0, decoded picture buffer parameters are decoded using the dpb_parameters( ) function, which is defined as follows:

| | Descriptor |
|---|---|
| dpb_parameters( maxSubLayersMinus1, | |
| subLayerInfoFlag ) { | |
| for( i = ( subLayerInfoFlag ? 0 : maxSubLayersMinus1 ); | |
| i <= maxSubLayersMinus1; i++ ) { | |
| max_dec_pic_buffering_minus1[i ] | ue(v) |
| max_num_reorder_pics[ i ] | ue(v) |
| max_latency_increase_plus1[i ] | ue(v) |
| } | |
| } | |

The same is performed at SPS level as follows (as highlighted by underscore):

| | Descriptor |
|---|---|
| seq_parameter_set_rbsp( ) { | |
| ... | |
| sps_max_sublayers_minus1 | u(3) |
| ... | |
| if( sps_max_sublayers_minus1 >0 ) | |
| sps_sublayer_dpb_params_flag | u(1) |
| if( sps_ptl_dpb_hrd_params_present_flag ) | |
| dpb_parameters( sps_max_sublayers_minus1, | |
| sps_sublayer_dpb_params_flag ) | |

Thus, when sps_ptl_dpb_hrd_params_present_flag equals to one, the same decoded picture buffer parameters function is called to decode the parameters. The syntax element sps_ptl_dpb_hrd_params_present_flag equal to 1 specifies that a profile_tier_level( ) syntax structure and a dpb_parameters( ) syntax structure are present in the SPS, and a general_hrd_parameters( ) syntax structure and an ols_hrd_parameters( ) syntax structure may also be present in the SPS. The syntax element sps_ptl_dpb_hrd_params_present_flag equal to 0 specifies that none of these four syntax structures is present in the SPS. The value of sps_ptl_dpb_hrd_params_present_flag shall be equal to vps_independent_layer_flag[GeneralLayerIdx[nuh_layer_id] ].

And the syntax element sps_sublayer_dpb_params_flag is used to control the presence of max_dec_pic_buffering_minus1[i], max_num_reorder_pics[i], and max_latency_increase_plus1[i] syntax elements in the dpb_parameters( ) syntax strucure in the SPS. When not present, the value of sps_sub_dpb_params_info_present_flag is inferred to be equal to 0.

Thus, sps_sublayer_dpb_params_flag serves only for dpb_parameters function. This means that if this function is not used, its value becomes redundant. It is generally avoided to code irrelevant information. The present principles advantageously remove redundant coding of sps_sublayer_dpb_params_flag by conditioning its coding on sps_ptl_dpb_hrd_params_present_flag.

An Embodiment of a Method for Obtaining a DPB Related Syntax Element

FIG. 3 illustrates an example of a method for obtaining a syntax data element sps_sublayer_dpb_params_flag related to a control of the presence of syntax elements in a decoded picture buffer parameters syntax structure in a Sequence Parameter Set according to a general aspect of at least one embodiment. The disclosed method is for instance used in an encoding method or a decoding method wherein the disclosed method is used for controlling the signaling of decoded picture buffer parameters.

Thus, according to an exemplary embodiment, the method 30 for obtaining the syntax data element sps_sublayer_dpb_params_flag comprises, in a step 31, a test on the syntax data element sps_ptl_dpb_hrd_params_present_flag relative to at least a control of the presence of a decoded picture buffer parameters syntax structure in the SPS a parameters of a decoded picture buffer used in the decoding of the picture or of a video. In case sps_ptl_dpb_hrd_params_present_flag is equal to zero, i.e. the flag specifies that the decoded picture buffer parameters syntax structure is not present (or signaled) in SPS, in a step 33, the sps_sublayer_dpb_params_flag is inferred to zero. In case sps_ptl_dpb_hrd_params_present_flag is equal to one, i.e. the flag specifies that the decoded picture buffer parameters syntax structure is present (signaled) in SPS, in a step 32, the sps_sublayer_dpb_params_flag is signaled in SPS, thus encoded at the encoder or decoded at the decoder. Advantageously, if sps_ptl_dpb_hrd_params_present_flag is zero, sps_sublayer_dpb_params_flag is not coded but inferred as zero. Advantageously; it also makes less confusion for encoder designers such that when someone sets the sublayer decoded picture buffer flag to one, it must perform what it is expected to do. If someone sets this flag to one, it is meant to control the above mentioned syntax elements. However, since dpb_parameters( ) function is not be used when sps_ptl_dpb_hrd_params_present_flag is zero, then the flag does not control the syntax elements. Therefore, the flag doesn't do what it is expected to. Finally, the present principles also save 1 bit at SPS level, which is not trivial when considering massive dataset or internet traffics.

A specification change is given below (the added section is underscored for reader's convenience):

| | Descriptor |
|---|---|
| seq_parameter_set_rbsp( ) { | |
| ... | |
| sps_max_sublayers_minus1 | u(3) |
| ... | |
| if( sps_max_sublayers_minus1 >0 | |
| && sps_ptl_dpb_hrd_params_present_flag) | |
| sps_sublayer_dpb_params_flag | u(1) |
| if( sps_ptl_dpb_hrd_params_present_flag ) | |
| dpb_parameters( sps_max_sublayers_minus1, | |
| sps_sublayer_dpb_params_flag ) | |

An Embodiment of a Method for Decoding a Picture

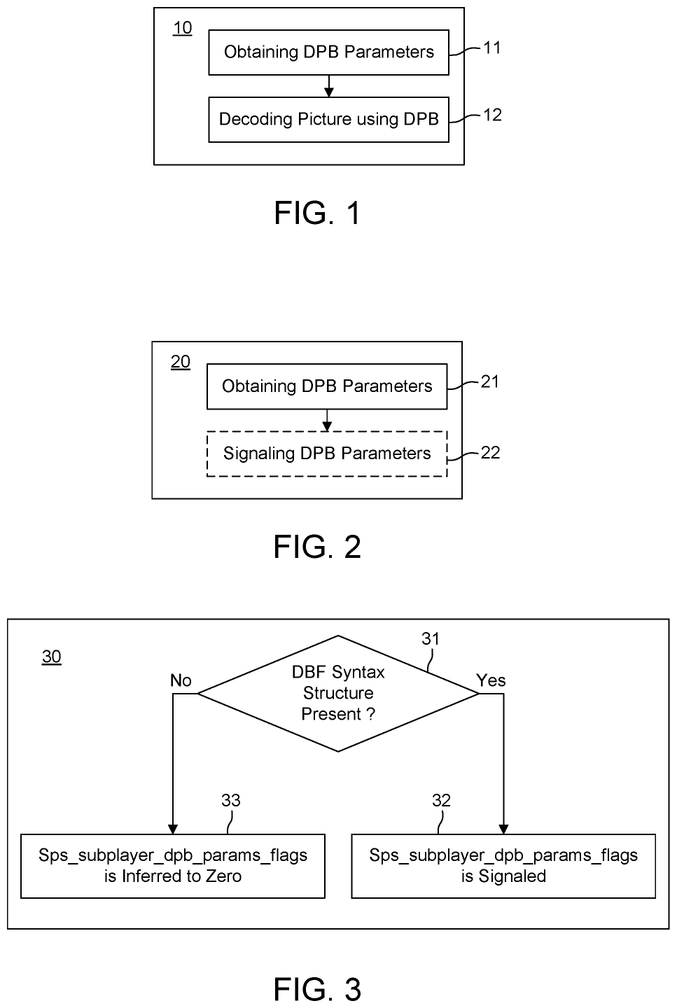

FIG. 1 illustrates an example of a decoding method according to a general aspect of at least one embodiment. Thus, the method 10 for decoding a picture comprises, in a step 11, obtaining parameters of a decoded picture buffer used in the decoding of the picture or of a video. As previously described, the parameters of the decoded picture buffer provide information on a buffer size, a maximum picture reorder number, and a maximum latency for one or more decoded picture to a decoder. The parameters are signaled in VPS or/and in SPS. The retrieving of parameters relative to the decoded picture buffer is controlled by a syntax data element sps_sublayer_dpb_params_flag used to the control of the presence of syntax elements in the DPB parameters syntax structure in SPS. The DPB, specified from the retrieved DPB parameters, is then used while decoding 12 the picture. According to a particular characteristic, the sps_sublayer_dpb_params_flag is inferred to zero when the syntax data element sps_ptl_dpb_hrd_params_present_flag at least used to control the presence of a DPB parameters syntax structure in the SPS specifies that DBP parameters syntax structure is not present in the SPS (ie sps_ptl_dpb_hrd_params_present_flag equal to zero). This embodiment advantageously avoids signaling, from an encoder to a decoder in the SPS, the flag sps_sublayer_dpb_params_flag in case sps_ptl_dpb_hrd_params_present_flag is equal to zero. According to another particular characteristic, the sps_sublayer_dpb_params_flag is decoded from SPS when the syntax data element sps_ptl_dpb_hrd_params_present_flag is set to one. This embodiment advantageously avoids removing redundant signaling of sps_sublayer_dpb_params_flag. Although not explicitly recited, the signaling and decoding of sps_sublayer_dpb_params_flag i is further conditioned on the syntax element sps_max_sublayers_minus1 being greater than 0, wherein sps_max_sublayers_minus1 specifies the maximum number of temporal sublayers that may be present in a coded layered video sequence.

An Embodiment of a Method for Encoding a Picture

FIG. 2 illustrates an example of an encoding method according to a general aspect of at least one embodiment. Thus, the method 20 for encoding a picture comprises, in a step 21, obtaining parameters of a decoded picture buffer used in the decoding of the picture or of a video. As previously described, the parameters of the decoded picture buffer provide information on a buffer size, a maximum picture reorder number, and a maximum latency for one or more decoded picture to a decoder. The parameters are signaled in VPS or/and in SPS. At the decoder, the retrieving of parameters relative to the decoded picture buffer is controlled by a syntax data element sps_sublayer_dpb_params_flag used to the control of the presence of syntax elements in the DPB parameters syntax structure in SPS. The DPB, specified from the retrieved DPB parameters, is then used while reconstructing the picture for further use in the encoding. According to a particular characteristic, the sps_sublayer_dpb_params_flag is inferred to zero when the syntax data element sps_ptl_dpb_hrd_params_present_flag at least used to control the presence of a DPB parameters syntax structure in the SPS specifies that DBP parameters syntax structure is not present in the SPS (ie sps_ptl_dpb_hrd_params_present_flag equal to zero). This embodiment advantageously avoids signaling, from an encoder to a decoder in the SPS, the flag sps_sublayer_dpb_params_flag in case sps_ptl_dpb_hrd_params_present_flag is equal to zero. In other words, the encoding of the syntax element sps_sublayer_dpb_params_flag in skipped. According to another particular characteristic, in an optional step 22, the sps_sublayer_dpb_params_flag is encoded in SPS when the syntax data element sps_ptl_dpb_hrd_params_present_flag is set to one. Besides, in the optional step 22, responsive to the sps_sublayer_dpb_params_flag indicating that the DPB parameters are signaled, the parameters of the DPB are encoded through the DPB parameters syntax structure in SPS. According to a variant embodiment, the signaling and encoding of sps_sublayer_dpb_params_flag is further conditioned with the syntax element sps_max_sublayers_minus1 being greater than 0, wherein sps_max_sublayers_minus1 specifies the maximum number of temporal sublayers that may be present in a coded layered video sequence.

Additional Embodiments and Information

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

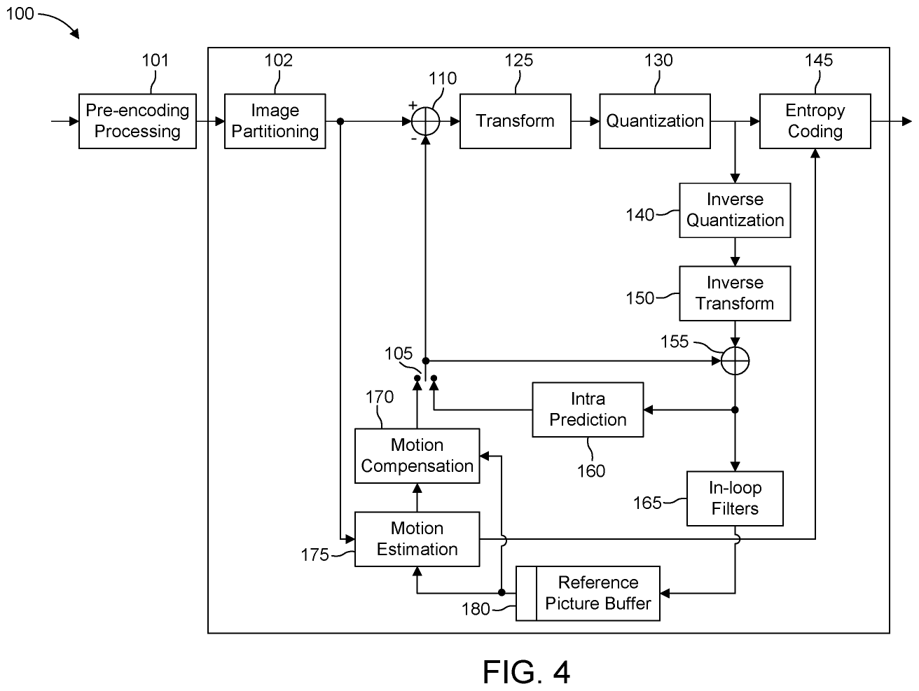

The aspects described and contemplated in this application can be implemented in many different forms. FIGS. 4, 5 and 6 below provide some embodiments, but other embodiments are contemplated and the discussion of FIGS. 4, 5 and 6 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined.

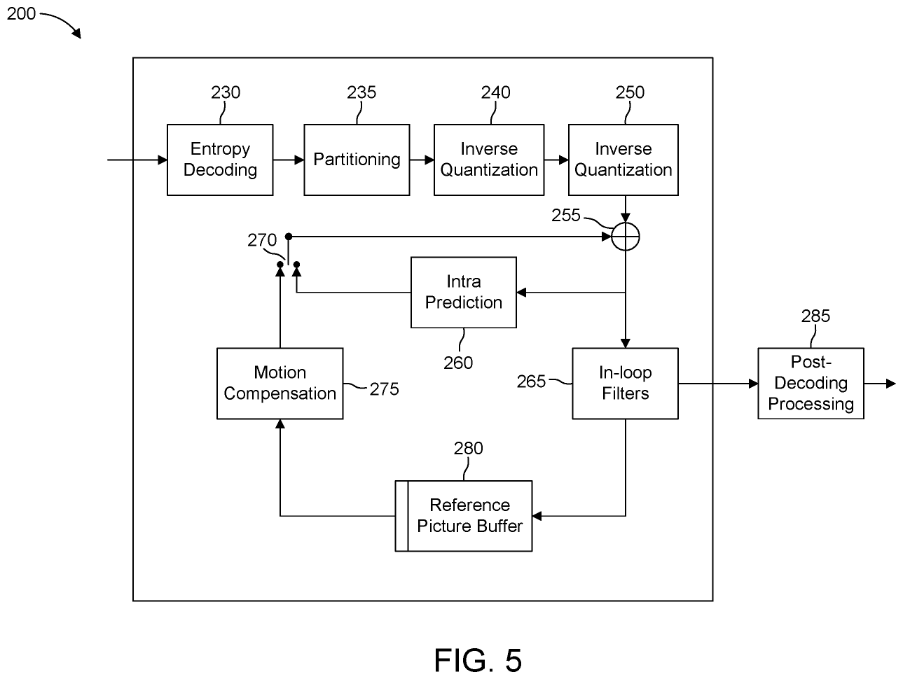

Various methods and other aspects described in this application can be used to modify modules, for example, the reference picture buffer (180, 280) of a video encoder 100 and decoder 200 as shown in FIG. 4 and FIG. 5. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application, for example the value of the flags. The specific values are for example purposes and the aspects described are not limited to these specific values.

FIG. 4 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 5 illustrates a block diagram of a video decoder 200. In the decoder 200, a bitstream is decoded by the decoder elements as described below. Video decoder 200 generally performs a decoding pass reciprocal to the encoding pass as described in FIG. 4. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

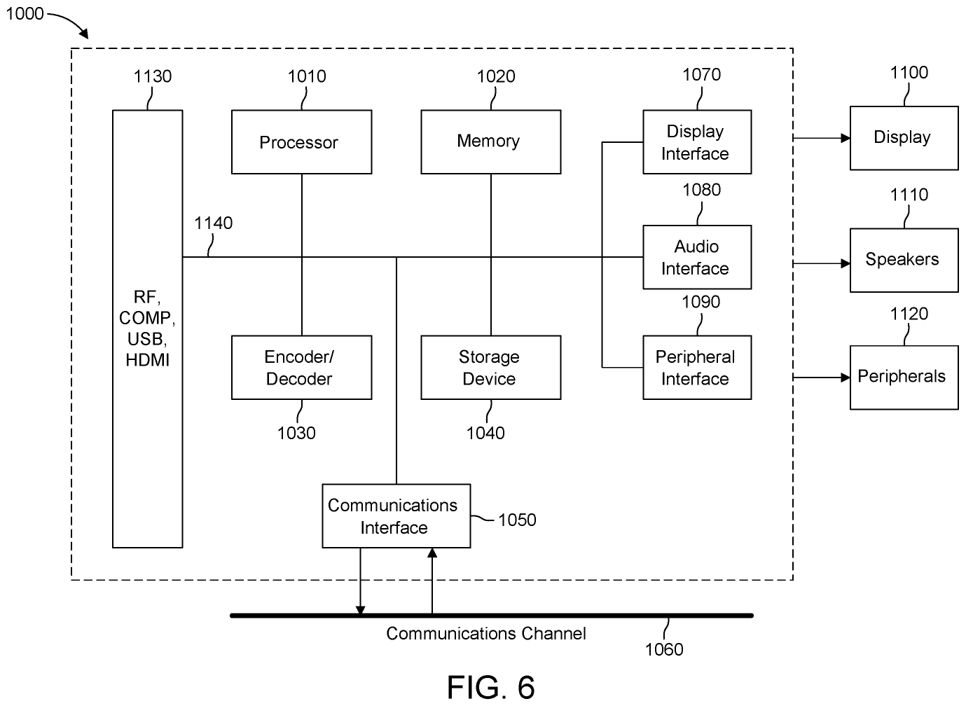

FIG. 6 illustrates a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 6, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor fora laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decoding the picture using the decoded picture buffer according to the specified parameters of the decoded picture buffer wherein a syntax data element sps_sublayer_dpb_params_flag related to a control of the presence of syntax elements in a decoded picture buffer parameters syntax structure in SPS is inferred to zero when a syntax data element sps_ptl_dpb_hrd_params_present_flag related to at least a control of the presence of a decoded picture buffer parameters syntax structure in the SPS specifies that decoded picture buffer parameters syntax structure is not present in the SPS.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, coding the picture and the specified parameters of the decoded picture buffer wherein a syntax data element sps_sublayer_dpb_params_flag related to a control of the presence of syntax elements in a decoded picture buffer parameters syntax structure in SPS is inferred to zero when a syntax data element sps_ptl_dpb_hrd_params_present_flag related to at least a control of the presence of a decoded picture buffer parameters syntax structure in the SPS specifies that decoded picture buffer parameters syntax structure is not present in the SPS. The coding of flag sps_sublayer_dpb_params_flag is thus skipped.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters for matrix based intra prediction. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
SDP (session description protocol), a format for describing multimedia communication sessions for the purposes of session announcement and session invitation, for example as described in RFCs and used in conjunction with RTP (Real-time Transport Protocol) transmission;
DASH MPD (Media Presentation Description) Descriptors, for example as used in DASH and transmitted over HTTP, a Descriptor is associated to a Representation or collection of Representations to provide additional characteristic to the content Representation;
RTP header extensions, for example as used during RTP streaming;
ISO Base Media File Format, for example as used in OMAF and using boxes which are object-oriented building blocks defined by a unique type identifier and length also known as ‘atoms’ in some specifications;
HLS (HTTP live Streaming) manifest transmitted over HTTP. A manifest can be associated, for example, to a version or collection of versions of a content to provide characteristics of the version or collection of versions.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
Modifying an encoding/decoding of a picture of a video, by inferring to zero a syntax data element sps_sublayer_dpb_params_flag when a syntax data element sps_ptl_dpb_hrd_params_present_flag specifies that decoded picture buffer parameters syntax structure is not present in the SPS;
Modifying an encoding/decoding of a picture of a video, by encoding/decoding a syntax data element sps_sublayer_dpb_params_flag when a syntax data element sps_ptl_dpb_hrd_params_present_flag specifies that decoded picture buffer parameters syntax structure is present in the SPS;
Modifying an encoding/decoding of a picture of a video, by inferring to zero a syntax data element sps_sublayer_dpb_params_flag when a syntax data element sps_ptl_dpb_hrd_params_present_flag specifies that decoded picture buffer parameters syntax structure is not present in the SPS and when a syntax data element sps_max_sublayers_minus1 is greater than zero;
Modifying an encoding/decoding of a picture of a video, by encoding/decoding a syntax data element sps_sublayer_dpb_params_flag when a syntax data element sps_ptl_dpb_hrd_params_present_flag specifies that decoded picture buffer parameters syntax structure is present in the SPS and when a syntax data element sps_max_sublayers_minus1 is greater than zero;
Modifying an encoding/decoding of a picture of a video using the specified signaling of DPB parameters in VPS/SPS.
A bitstream or signal that includes one or more of the described syntax elements, or variations thereof.
A bitstream or signal that includes syntax conveying information generated according to any of the embodiments described.
Inserting in the signaling syntax elements that enable the decoder to specify a DPB in a manner corresponding to that used by an encoder.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.
A TV, set-top box, cell phone, tablet, or other electronic device that performs transform skip and residual coding according to any of the embodiments described.
A TV, set-top box, cell phone, tablet, or other electronic device that performs transform skip and residual coding according to any of the embodiments described, and that displays (e.g. using a monitor, screen, or other type of display) a resulting image.
A TV, set-top box, cell phone, tablet, or other electronic device that selects (e.g. using a tuner) a channel to receive a signal including an encoded image, and performs transform skip and residual coding according to any of the embodiments described.
A TV, set-top box, cell phone, tablet, or other electronic device that receives (e.g. using an antenna) a signal over the air that includes an encoded image, and performs transform skip and residual coding according to any of the embodiments described.

1-18. (canceled)

19. A method, comprising:
decoding a syntax data element indicating whether a decoded picture buffer parameters syntax structure is present in a bitstream; and
responsive to the decoded picture buffer parameters syntax structure being present, decoding a syntax data element indicating whether one or more instances of parameters are present in a decoded picture buffer parameters syntax structure, and decoding a syntax data structure representative of parameters of a decoded picture buffer based on the indication of whether one or more instances of parameters are present in a decoded picture buffer parameters syntax structure, wherein the parameters of a decoded picture buffer provide information on a buffer size, a maximum picture reorder number, and a maximum latency for one or more decoded picture.

20. The method of claim 19, wherein the indication of whether one or more instances of parameters are present in a decoded picture buffer parameters syntax structure is inferred to zero responsive to an indication that the decoded picture buffer parameters syntax structure is not present in the bitstream.

21. The method of claim 19, wherein the syntax data element indicating whether one or more instances of parameters are present in a decoded picture buffer parameters syntax structure is signaled in a Sequence Parameter Set SPS.

22. The method of claim 19, wherein the syntax data element indicating whether a decoded picture buffer parameters syntax structure is present in a bitstream is signaled in a Sequence Parameter Set SPS.

23. A non-transitory computer readable medium comprising program code instructions to execute the method of claim 19 when executed on a computer.

24. An apparatus, comprising one or more processors configured to:
decode a syntax data element indicating whether a decoded picture buffer parameters syntax structure is present in a bitstream; and
responsive to the decoded picture buffer parameters syntax structure being present, decode a syntax data element indicating whether one or more instances of parameters are present in a decoded picture buffer parameters syntax structure, and decode a syntax data structure representative of parameters of a decoded picture buffer based on the indication of whether one or more instances of parameters are present in a decoded picture buffer parameters syntax structure, wherein the parameters of a decoded picture buffer provide information on a buffer size, a maximum picture reorder number, and a maximum latency for one or more decoded picture.

25. The apparatus of claim 24, wherein the indication of whether one or more instances of parameters are present in a decoded picture buffer parameters syntax structure is inferred to zero responsive to an indication that the decoded picture buffer parameters syntax structure is not present in the bitstream.

26. The apparatus of claim 24, wherein the syntax data element indicating whether a decoded picture buffer parameters syntax structure is present in a bitstream is signaled in a Sequence Parameter Set SPS.

27. The apparatus according to claim 24, wherein the syntax data element indicating whether one or more instances of parameters are present in a decoded picture buffer parameters syntax structure is signaled in a Sequence Parameter Set SPS.

28. A method, comprising:
encoding a syntax data element indicating whether a decoded picture buffer parameters syntax structure is present in a bitstream; and
responsive to the decoded picture buffer parameters syntax structure being present, encoding a syntax data element indicating whether one or more instances of parameters are present in a decoded picture buffer parameters syntax structure, and encoding a syntax data structure representative of parameters of a decoded picture buffer based on the indication of whether one or more instances of parameters are present in a decoded picture buffer parameters syntax structure, wherein said parameters of a decoded picture buffer provide information on a buffer size, a maximum picture reorder number, and a maximum latency for one or more decoded picture.

29. The method of claim 28, wherein the indication of whether one or more instances of parameters are present in a decoded picture buffer parameters syntax structure is inferred to zero responsive to an indication that the decoded picture buffer parameters syntax structure is not present in the bitstream.

30. The method of claim 28, wherein the syntax data element indicating whether a decoded picture buffer parameters syntax structure is present in a bitstream is signaled in a Sequence Parameter Set SPS.

31. The method of claim 28, wherein the syntax data element indicating whether one or more instances of parameters are present in a decoded picture buffer parameters syntax structure is signaled in a Sequence Parameter Set SPS.

32. A non-transitory computer readable medium comprising program code instructions to execute the method of claim 28 executed on a computer.

33. An apparatus, comprising one or more processors configured to:
encode a syntax data element indicating whether a decoded picture buffer parameters syntax structure is present in a bitstream; and
responsive to the decoded picture buffer parameters syntax structure being present, encode a syntax data element indicating whether one or more instances of parameters are present in a decoded picture buffer parameters syntax structure, and encode a syntax data structure representative of parameters of a decoded picture buffer based on the indication of whether one or more instances of parameters are present in a decoded picture buffer parameters syntax structure, wherein said parameters of a decoded picture buffer provide information on a buffer size, a maximum picture reorder number, and a maximum latency for one or more decoded picture.

34. The apparatus of claim 33, wherein the indication of whether one or more instances of parameters are present in a decoded picture buffer parameters syntax structure is inferred to zero responsive to an indication that the decoded picture buffer parameters syntax structure is not present in the bitstream.

35. The apparatus of claim 33, wherein the syntax data element indicating whether a decoded picture buffer parameters syntax structure is present in a bitstream is signaled in a Sequence Parameter Set SPS.

36. The apparatus of claim 33, wherein said syntax data element indicating whether one or more instances of parameters are present in a decoded picture buffer parameters syntax structure is signaled in a Sequence Parameter Set SPS.

37. A non-transitory computer readable medium containing coded video data, the coded video data comprising:
a syntax data element indicating whether a decoded picture buffer parameters syntax structure is present in the coded video data;
a syntax data element indicating whether one or more instances of parameters are present in a decoded picture buffer parameters syntax structure; and
a syntax data structure representative of parameters of a decoded picture buffer when the syntax data element indicates that the decoded picture buffer parameters syntax structure is present in the coded video data,
wherein the parameters of a decoded picture buffer provide information on a buffer size, a maximum picture reorder number, and a maximum latency for one or more decoded picture.
